(19) United States
(12) Patent Application Publication
(10) Pub. No.: US 2025/0105711 A1
(43) Pub. Date: Mar. 27, 2025

(54) METHOD FOR SHAPING A WAVE WINDING, AND WAVE WINDING SHAPED ACCORDING TO THIS METHOD

(71) Applicant: Schaeffler Technologies AG & Co. KG, Herzogenaurach (DE)

(72) Inventor: Florian Sell-Le Blanc, Karlsruhe (DE)

(73) Assignee: Schaeffler Technologies AG & Co. KG, Herzogenaurach (DE)

(21) Appl. No.: 18/730,784

(22) PCT Filed: Dec. 13, 2022
(86) PCT No.: PCT/DE2022/100946

§ 371 Date: Jul. 21, 2024

(30) Foreign Application Priority Data
Jan. 25, 2022 (DE) 10 2022 101 619.6

(51) Int. Cl. H02K 15/04; B23P 19/02

(52) U.S. Cl. CPC H02K 15/0433; B23P 19/02

(57) ABSTRACT

A method for shaping a one- or multi-part wave winding which is intended for insertion into a rotor, a stator or an insertion tool and consists of one or more conductor wires in a magazine is disclosed. The method includes introducing the wave winding, by means of straight portions of the conductor wires, into receptacles of the magazine; pressing the wave winding into the receptacles of the magazine, as a result of which shaping of the conductor wires is brought about and the conductor wires are molded to the receptacles; and them transferring the wave winding with the shaped conductor wires to an insertion tool, a stator, or a rotor. A wave winding, is produced according to the method, in which the straight wire portions have a cross section which is adapted to the groove.

### CROSS-REFERENCE TO RELATED APPLICATIONS

This application is the U.S. National Phase of PCT Appln. No. PCT/DE2022/100946 filed Dec. 13, 2022, which claims priority to DE 10 2022 101 619.6 filed Jan. 25, 2022, the entire disclosures of which are incorporated by reference herein.

### TECHNICAL FIELD

The disclosure relates to a method for shaping a wave winding and to a wave winding shaped according to the method.

### BACKGROUND

When assembling rotors or stators, continuous coil windings made of copper are used. A variety of methods have already been developed to produce rotors or stators with a high level of efficiency, the methods primarily concerning the production of such continuous coil windings.

The coil windings are produced as flat winding mats in the form of wave windings and then inserted into the slots of stators or rotors. The coil windings consist of a number of interwoven conductor wires which are bent several times in opposite directions so that straight wire portions or wire lobes of the conductor wires that are parallel to one another and are intended to fill the slots of stator or rotor bodies are connected by roof-like winding heads which protrude beyond the front side of the produced rotors or stators. To produce the coil winding, a flat and rotatable winding former as well as a wire handling device can be used as an initially flat winding mat. DE102015120963A1 describes an example of a method for producing wave windings.

After the flat winding mat has been produced on a winding former, it is removed from the former and transferred to a magazine. A magazine can, for example, be designed as an elongated linear magazine and has a plurality of receptacles for the conductor wires in the longitudinal direction. Alternatively, a magazine can also be designed as a rotary magazine. The receptacles are each formed between two ribs, resulting in slot-like receiving spaces. In the case of a linear magazine, these slot-like receiving spaces run perpendicular to the longitudinal direction in a width direction of the linear magazine. Typically, a linear magazine has a greater length in the longitudinal direction than the width in the width direction of the linear magazine. The winding mat can be compacted in the magazine and safely transferred from the manufacturing process step to a further process step in which the winding mat is inserted into a rotor or stator body. A magazine is intended to ensure that the single wires of the winding mat and in particular the straight wire portions of the winding mat intended for insertion into slots are not displaced against each other during handling and compaction. If a wave winding as described above is inserted into a magazine and in particular into a linear magazine, the result is that in a start region and an end region of the wave winding only individual conductor wires lie in the slots of the linear magazine, and in a subregion of the linear magazine a plurality of conductor wires can also lie one above the other in the slots of the linear magazine.

### SUMMARY

The present disclosure addresses the optimization of a wave winding which is to be inserted as a coil winding in a rotor or stator. Owing to the substantially cylindrical shape of rotors or stators, rotors or stators have slots that either have parallel slot flanks or are designed such that the tooth flanks of the teeth arranged between the slots are parallel. In the latter case, the result is conical or trapezoidal slot cross sections when viewed in cross section or axially with respect to the axis of rotation of the rotor or stator.

In the case of filling the slots, it is desirable to achieve the highest possible fill factor, i.e. that the slots are be filled as completely as possible with the conductor wires in order to use the available installation space as completely as possible for electromagnetically relevant components (conductor wires).

Therefore, the object of the disclosure is to provide a method with which a wave winding can be produced that makes better use of the available slot space of a rotor or stator.

The object is achieved with the features according to the claims and described herein.

According to the disclosure, a method is provided for shaping a one- or multi-part wave winding which is intended for insertion into a rotor, a stator or an insertion tool and consists of one or more conductor wires in a magazine, comprising the method steps: inserting the wave winding with straight wire portions of the conductor wires into the receptacles of the magazine; pressing the wave winding in the receptacles of the magazine, as a result of which the conductor wires are shaped and molded to the receptacles; transferring the wave winding with the shaped conductor wires to an insertion tool, a stator or a rotor. In particular, the straight wire portions of the conductor wires of the wave winding are pressed into the receptacles of the magazine, whereby the straight wire portions of the conductor wires are shaped and the conductor wires with the straight wire portions are molded to the receptacles. In particular, it is possible for the magazine to be designed as a linear magazine. Alternatively, the magazine can be designed as a rotary magazine.

The method described above has the advantage that the magazine with its receptacles serves as a kind of former for the shaping of the wave winding. Preferably, the receptacles of the magazine have the same cross section as the slots of the rotor or stator into which the wave winding is inserted after shaping and removal from the magazine.

The wave winding is preferably designed as a flat wire wave winding. Alternatively, it may also be conceivable to use the method according to the disclosure to shape wave windings which are designed as flat wire wave windings made of single conductors, as flat wire wave windings made of profile stranded conductors or as round wire wave windings. According to an optional but particularly expedient embodiment of the method, the method preferably follows the winding of the wave winding.

In a further embodiment of the method, the wave winding is inserted in a compact form, for example in one piece. In an alternative embodiment, it is conceivable that the wave winding is transferred in the form of single conductors.

According to a further embodiment of the method, during insertion of the wave winding, at least two conductor wires are inserted into the receptacles of the magazine in at least one subregion of the magazine. When using a linear magazine, there is the exception that only individual straight wire portions of the conductor wires lie in the receptacles of the linear magazine for the beginning and end of the wave winding to be inserted. Therefore, for the above method, it is possible that the pressing of the wave winding in these regions is carried out only for individual straight wire portions of the conductor wires in the receptacles of the magazine, whereby a shaping of the individual straight wire portions of the conductor wires takes place there and only the individual straight wire portions of the conductor wires are molded to the receptacles there. In the case of a rotary magazine, it may also be the case that individual straight wire portions lie in the receptacles in the start and end region of the wave winding. Nevertheless, the start and end regions can overlap in a rotary magazine in such a way that a plurality of straight wire portions of the conductor wires lie in each case in the receptacles. In a further variant, the at least two conductor wires, each with their straight wire portions, lie in a receptacle of the magazine. By inserting two or more conductor wires into the receptacle of the magazine, with a corresponding previous winding of the winding mat, it is possible to achieve both the shaping and the subsequent insertion of the wave winding into the rotor or stator for a plurality of layers and/or a plurality of phases of the coil. In this way, the cycle time can be reduced and the process can be more efficient.

According to a further optional embodiment of the method, the wave winding is inserted into the magazine in a preferred embodiment in such a way that a slot offset is achieved when the wave winding is transferred from the magazine. For this purpose, the wave winding is designed in particular as a stepped winding.

It is also possible for the conductor wires of the wave winding to be inserted into the receptacles of the magazine in a sequence of a stepped winding. In an exemplary embodiment, two conductor wires could be inserted in a first receptacle, four conductor wires could be inserted in a directly adjacent second receptacle, and six conductor wires of the wave winding could be inserted in a further third receptacle directly adjacent to the second receptacle, wherein only four conductor wires are inserted in a fourth receptacle directly adjacent to the third receptacle and two conductor wires are inserted accordingly in a fifth receptacle directly adjacent to the fourth receptacle. It is understood that the stepped winding described above is not limited to the 2-4-6-4-2 configuration, but other configurations are also conceivable.

The method according to any one of the preceding claims, wherein a wave winding with single, double or multiple turns is inserted into the receptacles of the magazine. In this way, the wave winding is already configured as a possible coil winding for a multi-phase electric motor and the corresponding conductor wires to be located in the respective slots are shaped, in particular in their straight wire portions, into the matching cross sections.

According to a further embodiment of the method, the conductor wires in the receptacles are shaped to form a substantially conical cross section. This is particularly advantageous if the tooth flanks of the rotor or stator, which is intended for the insertion of the wave winding, are designed to be parallel. Owing to the parallel tooth flanks, the slot flanks of a substantially cylindrical rotor or stator body are not parallel and the result is a substantially trapezoidal slot cross section. The conical cross section results in a particularly efficient use of the available slot space by the conductor wires of the wave winding.

According to a further development of the method, the shaping of the conductor wires in the receptacles is carried out consecutively. By means of a consecutive or sequential shaping of the conductor wires, the method can advantageously be designed in such a way that, for example, a rolling tool is rolled along the magazine over the conductor wires running perpendicular thereto and lying in the receptacles and presses the conductor wires sequentially into the receptacles so that the conductor wires are molded to the shape of the receptacles. In a further development, it is also possible for the degree of shaping to vary along the magazine. For example, it is possible for a sequential shaping at a first position of the magazine to shape the conductor wire(s) lying in a first receptacle with a first geometry to a greater extent than a shaping in a second receptacle with a second geometry at a second position of the magazine. In this way, different geometries can be formed in a continuous wave winding. This is particularly advantageous when a continuous wave winding is inserted into a rotor or stator body in a plurality of layers.

According to a further embodiment of the disclosure, the shaping of the conductor wires in the receptacles takes place synchronously or in groups synchronously. Preferably, the synchronous shaping or synchronous shaping in groups is carried out by means of one or more press stamps, which engage in the receptacles of the magazine and press the conductor wires lying therein. The synchronous shaping in groups takes place in such a way that the press stamp presses a plurality (approximately two or a multiple thereof) of receptacles at the same time, the press ram then being offset from the magazine by the corresponding number of receptacles and the press ram or another press ram in turn pressing in the plurality of receptacles. In this way, a different shaping within the continuous wave winding can also be achieved by exchanging the press stamp and providing different receptacle geometries.

Therefore, according to a further development of the method, the type of shaping or the degree of shaping varies along the magazine.

In a further development of the method, there is almost no axial displacement of the conductor wires during pressing, i.e. a displacement in the width direction of the magazine. In particular, in this further development, no axial displacement in the width direction of the magazine is supposed to occur for the straight wire portions of the conductor wires. This can be achieved in particular by designing the receptacles with respect to the wire width such that the receptacles have a width which at least corresponds to the wire width and preferably corresponds to the wire width. As a result, the wires are only deformed in the later circumferential direction relative to the slot of the stator or rotor. This has a positive effect on the condition of the wire insulation.

In a further embodiment of the method, a part of the conductor wires and in particular the straight wire portions of a part of the conductor wires in the receptacle of the magazine are compressed in relation to the width of the receptacle, i.e. in the case of a linear magazine in the longitudinal direction of the magazine, and a part of the conductor wires and in particular the straight wire portions of a part of the conductor wires in the receptacle of the magazine are stretched preferably in relation to the width of the receptacle or in the longitudinal direction, in the case of a linear magazine. This has the advantage that, on average, the lowest possible degree of shaping is achieved for the pressing process across all changes in shape in a receptacle. For this purpose, for example, a corresponding wire width can be selected in relation to a mean width of the receptacle or the receptacle can be used with its mean width corresponding to the wire width. If there are a plurality of conductor wires in the receptacle, the result for a conical cross section of the receptacle is that, with a corresponding configuration of the wire width and/or the width of the receptacle, the wires which are pressed in the narrower part of the receptacle with a conical cross section are compressed in relation to the width of the receptacle, and the wires which are pressed in the wider part of the receptacle with a conical cross section are stretched in relation to the width of the receptacle. Overall, however, there is minimal shaping for all conductor wires, which means that, for all conductor wires considered, their insulation is stressed to a small degree by the shaping.

In a further embodiment of the method, the magazine is designed as a segmented magazine and, for the transfer of the pressed wave winding, the magazine is divided into its segments for the removal of the wave winding. This is particularly advantageous if the shaping is carried out in such a way that removal of the shaped wires is not immediately possible, or if handling of the magazine is necessary for removal and further transport of the shaped wave winding. A segmented design of the magazine preferably enables removal or provides new, less complex removal options.

According to a further development of the method, it is possible for the magazine to be rotated to remove the shaped wave winding. This is particularly advantageous in the case of a magazine in the form of a linear magazine with respect to the removal of a shaped wave winding with a conical design of the cross section of the receptacles tapering towards a closed end of the receptacles.

Externally slotted components or assemblies are preferably suitable for the installation or insertion of a wave winding produced according to the method described. An externally slotted stator or rotor would be advantageous as a component. As an assembly, a single or a plurality of rotor or stator segments would be advantageous. Especially in combination with various segmentation strategies, the application of this method is beneficial with respect to product properties.

The disclosure further relates to a wave winding, produced according to the method described above, comprising straight wire portions and winding heads connecting the straight wire portions, wherein straight wire portions are provided for insertion into the slot of a rotor or stator body of a rotor or stator, characterized in that the straight wire portions in particular have a cross section overall which substantially corresponds to the cross section of the slot. The advantages described above also apply to such a wave winding. In particular, optimum utilization of the slot space available in the preferably substantially cylindrical rotor or stator body is achieved. Another advantage of the method described above is that the insulation of the wave winding is stressed as little as possible.

### BRIEF DESCRIPTION OF THE DRAWINGS

Further features, details and advantages of the disclosure result from the wording of the claims and from the following description of exemplary embodiments with reference to the drawings. In the drawings:

FIGS. 1A and 1B: show a schematic representation of the method sequence for two different variants for shaping the conductor wires in a linear magazine;

FIG. 2: shows a schematic partial representation of a top view of the linear magazine with an inserted wave winding;

FIG. 3: shows a schematic representation of shaped wires;

FIG. 4: shows a schematic partially axial sectional view of a part of a wave winding inserted into a rotor or stator body.

### DETAILED DESCRIPTION

Unless otherwise stated, the reference signs are used consistently below. Unless otherwise stated, the reference signs in the text always refer to all the figures. Likewise, unless otherwise stated, all reference signs in the figures always refer to the entire description of the exemplary embodiments below.

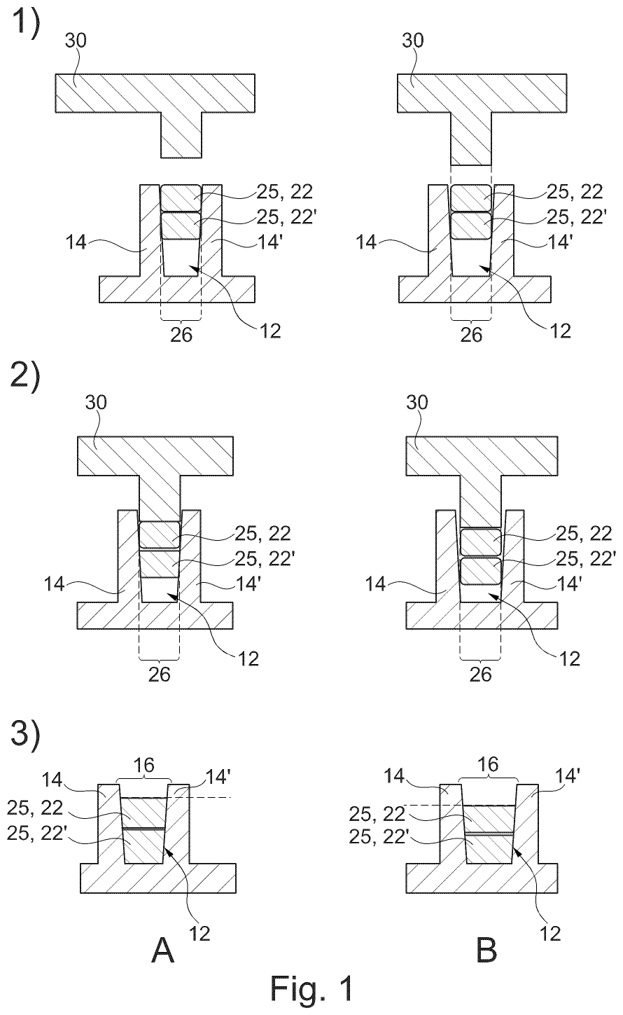

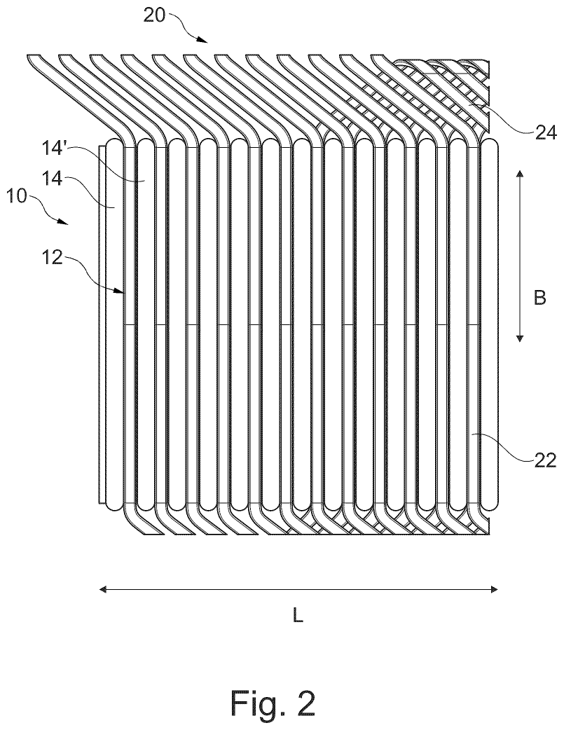

Below, FIG. 1 shows a receptacle 12 with straight wire portions 22, 22′, 22″, 22″ of the wave winding 20 lying therein. It can be seen from FIG. 2 that a linear magazine 10 has a plurality of such receptacles 12 in its longitudinal direction L.

FIG. 1A and FIG. 1B each show a schematic representation of the method sequence for two different variants for shaping the conductor wires 25 in the linear magazine 10. For the method, straight wire portions 22, 22′, 22″, 22″ of conductor wires 25 of a wave winding 20 are first inserted into a linear magazine 10. For this purpose, the linear magazine 10 has receptacles 12, with the receptacles 12 being delimited in the longitudinal direction L of the linear magazine by ribs 14, 14′. The receptacles 12 have an opening 16 via which the straight wire portions 22, 22′, 22″, 22″ can be inserted into the receptacles 12 so that the straight wire portions 22, 22′, 22″, 22′ lie in the receptacles 12 perpendicular to the longitudinal direction L of the linear magazine, i.e. in a width direction B. In this exemplary embodiment, the receptacle 12 has a receiving space with a conical cross section, the width of the receptacle 12 in the region of the opening 16 of the receptacle 12 being greater than in a lower region of the receptacle 12.

According to the method sequence from FIG. 1A, the conductor wires 25 with their straight portions 22, 22′, 22″, 22″ are inserted into the receptacle 12, the wire width 26 substantially corresponding to the width of the receptacle 12 in the upper region and the width of the receptacle 12 decreasing with increasing depth of the receptacle and being smaller than the wire width 26.

In FIG. 1B, the conductor wires 25 with their straight portions 22, 22′, 22″, 22″ are inserted into the receptacle 12, the width of the receptacle 12 decreasing with increasing depth of the receptacle 12 and the wire width 26 substantially corresponding to the width of the receptacle 12 in the lower region. In the region of the receptacle 12 which is close to the opening 16, the width of the receptacle 12 is greater than the wire width 26.

In the following step 2), the wave winding 20 with its straight wire portions 22, 22′, 22″, 22″ lying in the receptacles 12 of the linear magazine 10 is pressed by means of a pressing tool 30, as a result of which the conductor wires 25 are shaped and the conductor wires 25 with their straight wire portions 22, 22′, 22″, 22′ are molded to the receptacles 12 and in particular to the ribs 14, 14′.

For the variant according to FIG. 1A, a wire width of 26 was chosen which corresponds approximately to the mean width of the receptacle 12. As a result, after pressing, the lowest possible degree of shaping is achieved on average across all shape changes of the conductor wires 25, whereby the insulation of the conductor wires 25 is subjected to little stress. The lower straight wire portion 22′ is compressed in the direction of the receptacle width or in the longitudinal direction L of the linear magazine 10, and the upper wire portion 22 is stretched in the direction of the receptacle width or in the longitudinal direction L of the linear magazine 10.

For the variant according to FIG. 1B, the width of the receptacle 12 or the extension of the receptacle in the longitudinal direction L of the linear magazine was selected such that the wire width 26 is smaller than or equal to the smallest width of the conically tapered receptacle 12. This results in all straight wire portions 22, 22′ being stretched in the longitudinal direction L of the linear magazine 10. There is no displacement of the straight wire portions 22, 22′ perpendicular to this, which advantageously prevents any insulation damage from occurring.

In step 3), the final state of the shaped conductor wires 25 in the linear magazine 10 is shown. In a subsequent step (not shown), the conductor wires 25 or the wave winding 20 are removed from the linear magazine 10 and transferred into an insertion tool or into a rotor or stator body 100.

It can be seen that the lower straight wire portion 22′ in FIG. 1A was stretched in the longitudinal direction L of the linear magazine and the upper straight wire portion 22 in FIG. 1A was compressed in the longitudinal direction L of the linear magazine 10 by the shaping. In FIG. 1B, both straight wire portions 22, 22′ were compressed in the longitudinal direction L by the shaping, resulting in a lower overall height of the wire pack compared to the design of the linear magazine 10 according to FIG. 1A.

A person skilled in the art will recognize that more than two layers of straight wire portions 22, 22′, 22″, 22″ can lie in the receptacle 12 of the linear magazine 10. The pressing is carried out in step 2) with a suitable pressing tool 30, which engages in the receptacles 12 and there causes the shaping of the straight wire portions 22, 22′, 22″, 22′ or conductor wires 25 by molding them to the ribs 14, 14′ of the receptacles 12. The shaping can be carried out for all receptacles 12 simultaneously (in FIG. 1 only one receptacle 12 of the linear magazine 10 is shown representatively), for example by means of a press stamp, but it is also conceivable that the straight wire portions 22, 22′, 22″, 22′ are rolled into the receptacles 12 of the linear magazine 10 by a roller equipped with press ribs. Of course, the variants with regard to the configuration of the width of the receptacles 12 relative to the wire width 26 according to FIGS. 1A and 1B can exist together within a linear magazine 10, wherein the width of the receptacles 12 can also change in the course of the linear magazine 10, i.e. in its longitudinal direction L.

For the sake of clarity, FIG. 2 shows a schematic partial representation of a top view of the linear magazine 10 with an inserted wave winding 20. It can be seen that the wave winding 20 with the straight wire portions 22 of the conductor wires lies in the receptacles 12 of the linear magazine 10. The receptacles 12 are each delimited by ribs 14, 14′. In the course of the conductor wires 25, the straight wire portions 22 are adjoined by winding heads 24 of the wave winding 20, which in this exemplary embodiment are located outside the receptacles 12 and outside the linear magazine 10. The winding heads 24 are located outside the receptacles 12 in the width direction B of the linear magazine 10.

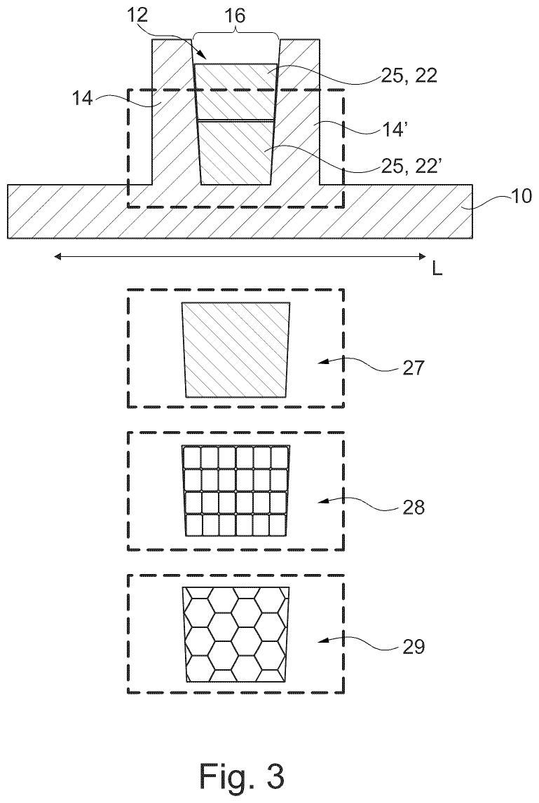

FIG. 3 shows a schematic representation of shaped conductor wires 24, in which the conductor wires 24 can be formed as single wires 27, as shaped stranded wires 28 or as loose stranded wires 29. The internal shaping of the conductor wires 25 shown in detail in FIG. 3 is configured accordingly.

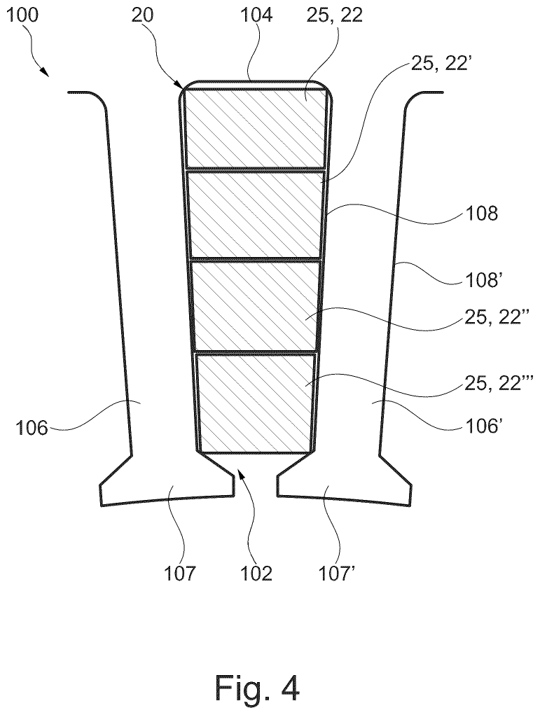

FIG. 4 shows a schematic partially axial sectional view of a part of a wave winding 20 inserted in a rotor or stator body 100. The wave winding 20 is inserted into a slot 102, with the slot 102 being delimited on both sides by teeth 106, 106′ with parallel tooth flanks 108, 108′, resulting in a radially different slot width, which in the exemplary embodiment shown increases with increasing radius. The slot 102 is delimited radially outwards by a slot base 104 and radially inwards by yoke portions 107, 107′ of the teeth 106, 106′. The wave winding 20 almost completely fills the slot 102 with the straight wire portions 22, 22′, 22″, 22″ shaped according to the method described above. Here, not only two layers of conductor wires, but four layers of conductor wires 25 or straight wire portions 22, 22′, 22″, 22″ are inserted into a slot 102 of a rotor or stator body 100. In one variant, these four layers may each have been formed in the receptacles 12 of the linear magazine 10, or the wave winding 20 was formed in two layers, wherein the wave winding 20 was then inserted into the substantially cylindrical rotor or stator body 100 in two revolutions. It is understood that the shaping in the linear magazine 10 must then take place according to the later position in the rotor or stator body, the receptacle geometry changing accordingly in the longitudinal direction L of the linear magazine 10 in order to be adapted to the radially changing slot cross section of the rotor or stator body 100. For this purpose, the linear magazine 10 can have a fixed geometry or, to a certain degree, movable or exchangeable ribs 14, 14′ or boundaries of the receptacles 12.

All of the features and advantages arising from the claims, description and drawings, including structural details, spatial arrangements and method steps, may be essential to the disclosure either alone or in various combinations.

### LIST OF REFERENCE SIGNS

10 Magazine, linear magazine
12 Receptacle
14, 14′ Rib
16 Opening
20 Wave winding
22, 22′, 22″, 22″ Straight wire portion
24 Winding head
25 Conductor wire
26 Wire width
27 Single wire
28 Shaped stranded wire
29 Loose stranded wire
30 Pressing tool
100 Rotor or stator body
102 Slot
104 Slot base
106, 106′ Tooth
107, 107′ Yoke portion
108, 108′ Tooth flank
L Longitudinal direction
B Width direction

1. A method for shaping a wave winding which is intended for insertion into a rotor, stator or insertion tool and has one or more conductor wires in a magazine, comprising the method steps:
inserting the wave winding with straight portions of the conductor wires in receptacles of the magazine;
pressing the wave winding in the receptacles of the magazine, wherein the conductor wires are shaped and the conductor wires are molded to the receptacles; and
transferring the wave winding with the shaped conductor wires to the insertion tool or the stator or the rotor.

2. The method according to claim 1, wherein, during insertion of the wave winding, at least two conductor wires are inserted in each case into the receptacles of the magazine at least in a subregion of the magazine.

3. The method according to claim 1, wherein a wave winding with single, double or multiple turns is inserted into the receptacles of the magazine.

4. The method according to claim 1, wherein the conductor wires in the receptacles are shaped to form a conical cross section.

5. The method according to claim 1, wherein the shaping of the conductor wires in the receptacles takes place consecutively.

6. The method according to claim 1, wherein the shaping of the conductor wires in the receptacles takes place synchronously or in groups synchronously.

7. The method according to claim 1, wherein no axial displacement of the conductor wires takes place during pressing.

8. The method according to claim 1, wherein a part of the conductor wires in the receptacle of the magazine is compressed in a longitudinal direction of the magazine and a part of the conductor wires in the receptacle is stretched in the longitudinal direction of the magazine.

9. The method according to a claim 1, wherein the magazine is designed as a segmented magazine and, for the transfer of the pressed wave winding, the magazine is divided into its segments for removal of the wave winding.

10. The wave winding produced by the method according to claim 1, comprising straight wire portions and winding heads connecting the straight wire portions, wherein the straight wire portions are intended for insertion into a slot of the rotor or stator body of the rotor or stator, wherein the straight wire portions have a cross section which substantially corresponds to the cross section of the slot.
